(19) United States
(12) Patent Application Publication
(10) Pub. No.: US 2004/0203382 A1
(43) Pub. Date: Oct. 14, 2004

(54) Method and system for providing wireless multimedia services using bluetooth

(76) Inventor: Ki-Eob Park, Seoul (KR)

Correspondence Address: LADAS & PARRY, 26 WEST 61ST STREET, NEW YORK, NY, 10023, US

(21) Appl. No.: 10/373,570

(22) Filed: Feb. 25, 2003

Related U.S. Application Data
(63) Continuation of application No. PCT/KR01/01458, filed on Aug. 29, 2001.

(30) Foreign Application Priority Data
Sep. 1, 2000 (KR) KR2000/051597

(51) Int. Cl. H04B 5/00

(52) U.S. Cl. 455/41.2; 455/88

(57) ABSTRACT

Disclosed are a system for and a method of providing wireless multimedia services using Bluetooth. The system includes at least one Bluetooth terminal having an embedded Bluetooth chip able to transfer data, a converter establishing a Bluetooth network with the Bluetooth terminal, the converter being connected with a wired network, and serving to convert data used in the Bluetooth network and the wired network, and a gateway linked to the converter and adapted to perform a conversion between the data converted by the converter and an Internet packet. In accordance with the present invention, it is possible to not only inexpensively provide domestic multimedia mobile communication services between Bluetooth terminals, but also inexpensively use international multimedia services conventionally incurring a considerable charge.

### TECHNICAL FIELD

The present invention relates to a method for providing wireless multimedia services using Bluetooth, and more particularly to a system using a Bluetooth converter, and a gateway capable of supporting a voice over IP (VoIP), for an Internet access of a terminal configured to support Bluetooth.

### BACKGROUND ART

Recently, communication methods using Bluetooth have been highlighted as a wireless communication method between appliances located in proximity to each other. Bluetooth is a communication protocol for enabling high-speed data transmission and reception among various electronic appliances using a radio frequency without using any physical cable. For example, Bluetooth is usable for mobile computing via wireless connection between a notebook type personal computer and a mobile telephone, or for wireless connection between a keyboard or mouse and a personal computer. Bluetooth systems have to use an unlicensed band for universal acceptance and usage. Thus, the industrial, scientific, and medical (ISM) band around 2.4 GHz has been selected for Bluetooth. For multiplexing, Bluetooth uses a spectrum spreading technique. For spread spectrum, a frequency hopping technique is used, taking into consideration interference characteristics. Bluetooth supports two kinds of data transfer modes which use synchronous connection oriented (SCO) links and asynchronous connectionless (ACL) links, respectively. SCO links are mainly used for transfer of voice data. A time division duplex (TDD) scheme is applied between the transmitter and the receiver. Slaves, which are wirelessly connected to a master, may use different data transfer modes. The data transfer mode of each slave may be changed, if desired.

Currently, development of diverse solutions using Bluetooth is ongoing. This development is focused on methods of mounting a Bluetooth circuit on existing terminals or appliances, and methods of installing a Bluetooth system in various environments. For example, U.S. Pat. No. 6,069,588 filed on Feb. 11, 1999 by Ericsson Inc. discloses a method for connecting Bluetooth terminals located in spaces isolated from each other by walls or the like, using Bluetooth antennas each coaxially coupled to an associated one of the Bluetooth terminals. This method is a technique focused on implementation of a Bluetooth network.

Meanwhile, VoIP technique has been highlighted as a technique capable of inexpensively providing Internet phone services. FIG. 10 is a concept diagram illustrating a conventional Internet phone service providing method using a VoIP protocol. In the case of FIG. 10, Internet phone services may be implemented using a wired Internet phone service providing method in which a public switched telephone network (PSTN) 1003 and the Internet 1007 are linked with each other, and a wireless Internet phone service providing method in which a mobile telephone network 1009 is also linked with the linked PSTN 1003 and the Internet 1007.

The wired Internet phone service providing method is implemented in three connection types, that is, a connection type in which computers 1015 directly connected to the Internet 1007 are connected to each other, a connection type in which a computer 1015 and a telephone 1001 are connected to each other, and a connection type in which telephones 1001 are connected to each other. In the second and third connection types, the Internet 1007 and PSTN 1003 are linked with each other. For the connection of a heterogeneous network, a VoIP gateway 1005 has to be provided. The VoIP gateway 1005 performs a conversion of a pulse code modulation (PCM) signal of 64 Kbps into Internet packets. In this data conversion process, data compression may also be performed. H.323 protocol is known as a protocol used in the data conversion and compression.

For such Internet phone services, wired Internet phone services mentioned above have been mainly used. However, demand for wireless Internet phone services has recently been increased in pace with the tremendous increase in the number of subscribers to wireless communication networks. In the case of FIG. 10, such wireless Internet phone services provided for a mobile terminal 1013 are implemented by linking, with the Internet 1007, a mobile telephone network 1009, to which a base station 1011 receiving a signal transmitted from the mobile terminal 1013 belongs. The tremendous increase in the number of subscribers to wireless communication networks and the rate of using the Internet has also resulted in an increased demand for wireless data services. In such wireless data services, data transmission is carried out through mobile terminals.

Wireless Internet phone services and wireless data services mentioned above can be provided using existing mobile telephone services or IMT-2000 services. However, where mobile telephone services or IMT-2000 services are used, the user of the mobile terminal 1013 should pay an extra charge to the provider of mobile telephone services and the provider of Internet phone services. For this reason, there is a problem of incurring considerable expenses.

Financial burden of users in association with conventional wireless multimedia services can be considerably reduced by linking the Internet with a Bluetooth network. That is, where the Internet is connected with a Bluetooth network, the user can receive wireless Internet phone services without paying an extra charge to the mobile telephone service provider (or IMT-2000 service provider) and the Internet phone service provider.

### DISCLOSURE OF THE INVENTION

Therefore, an object of the present invention is to provide a method and system for providing wireless multimedia services through a connection between a Bluetooth network and the Internet, thereby being capable of inexpensively providing wireless multimedia services.

In association with the above mentioned object, the present invention has another object to provide a Bluetooth converter having a function for converting a Bluetooth packet used in a Bluetooth network into the format of a PCM signal used in a PSTN or data provided over the Internet. The Bluetooth converter completely supports three kinds of voice codes supported by Bluetooth networks. The Bluetooth converter is configured to operate as a master every time data exchange is made.

The present invention also has another object to establish a link between a Bluetooth network and the Internet in accordance with a link of the Bluetooth converter with a gateway. For the link of voice data, a VoIP gateway may be used as the gateway. Preferably, the Bluetooth converter and gateway are connected to each other by a dedicated line. Alternatively, other kinds of networks may be used in place of the dedicated line.

The present invention has a further object to eventually provide wireless multimedia services to the user of a Bluetooth terminal in accordance with a link between a Bluetooth network using the Bluetooth converter and the Internet.

In accordance with one aspect, the present invention provides a system for providing wireless multimedia services using Bluetooth, comprising:

at least one Bluetooth terminal unit having an embedded Bluetooth chip able to transfer data;

a converter unit establishing a Bluetooth network with the Bluetooth terminal unit, the converter unit being connected with a wired network, and serving to convert data used in the Bluetooth network and the wired network; and

a gateway unit linked to the converter unit and adapted to perform a conversion between the data converted by the converter unit and an Internet packet.

In accordance with another aspect, the present invention provides a method for providing wireless multimedia services using Bluetooth, comprising the steps of:

establishing a Bluetooth network between at least one Bluetooth terminal and a Bluetooth converter;

receiving data from the Bluetooth terminal by the Bluetooth converter, and generating data converted from the received data by the Bluetooth converter;

transferring the converted data to a wired network by the Bluetooth converter.

In accordance with the wireless multimedia service providing method using Bluetooth in accordance with an embodiment of the present invention, a piconet is established between the Bluetooth terminal having an embedded chip supporting a Bluetooth protocol and the Bluetooth converter. Once the Bluetooth network is established, the user of the Bluetooth terminal who desires to receive multimedia services sends multimedia data to the Bluetooth converter, by use of the Bluetooth terminal. The Bluetooth converter, which receives the multimedia data, converts the received data into a packet used Bluetooth networks, and transfers the packet to a transmitting-end gateway. Where the packet contains a voice signal, it is transferred to a VoIP gateway. The signal converted by the Bluetooth converter is packetized into an Internet packet by the gateway. The packetized signal is received, via the Internet, by a receiving-end gateway which, in turn, releases the packet to recover original data. Thus, the original data is connected to a receiving-end terminal.

In accordance with another embodiment of the present invention, the Bluetooth converter may have a function for directly converting a packet used in Bluetooth networks into an Internet packet.

### BRIEF DESCRIPTION OF THE DRAWINGS

The above and other objects, features and other advantages of the present invention will be more clearly understood from the following detailed description taken in conjunction with the drawings, in which:

FIG. 1 is a concept diagram illustrating a wireless multimedia service providing method using Bluetooth in accordance with the present invention;

FIG. 2a is a concept diagram illustrating the structure of a piconet, that is, a Bluetooth network established by a master and slaves;

FIG. 2b is a flow chart illustrating a procedure for establishing a Bluetooth network between a Bluetooth converter and a Bluetooth terminal in accordance with the present invention;

FIG. 3 is a concept diagram illustrating the protocol architecture of the Bluetooth network used for transmission of voice data between the Bluetooth converter and the Bluetooth terminal in accordance with the present invention;

FIGS. 4a and 4b are flow charts respectively illustrating signaling procedures for establishing a channel required for data transfer between the Bluetooth converter and the Bluetooth terminal in accordance with the present invention;

FIGS. 5a and 5b are flow charts respectively illustrating signaling procedures for changing the parameters of a channel previously established between the Bluetooth converter and the Bluetooth terminal in accordance with the present invention;

FIG. 6a is a schematic view illustrating the structure of a packet used in a Bluetooth network;

FIG. 6b is a concept diagram illustrating a multiplexing transfer method performed between the Bluetooth converter and the Bluetooth terminal in accordance with the present invention;

FIG. 7 is a block diagram illustrating the configuration of a Bluetooth converter in accordance with an embodiment of the present invention;

FIG. 8 is a concept diagram corresponding to the part of a wireless multimedia service providing system associated with a receiving terminal according to the present invention;

FIG. 9 is a flow chart illustrating a method for providing wireless multimedia services in accordance with the present invention; and

FIG. 10 is a concept diagram illustrating a conventional Internet phone service providing method.

### BEST MODE FOR CARRYING OUT THE INVENTION

Now, a wireless multimedia service providing system and method using Bluetooth in accordance with the present invention will be described in detail.

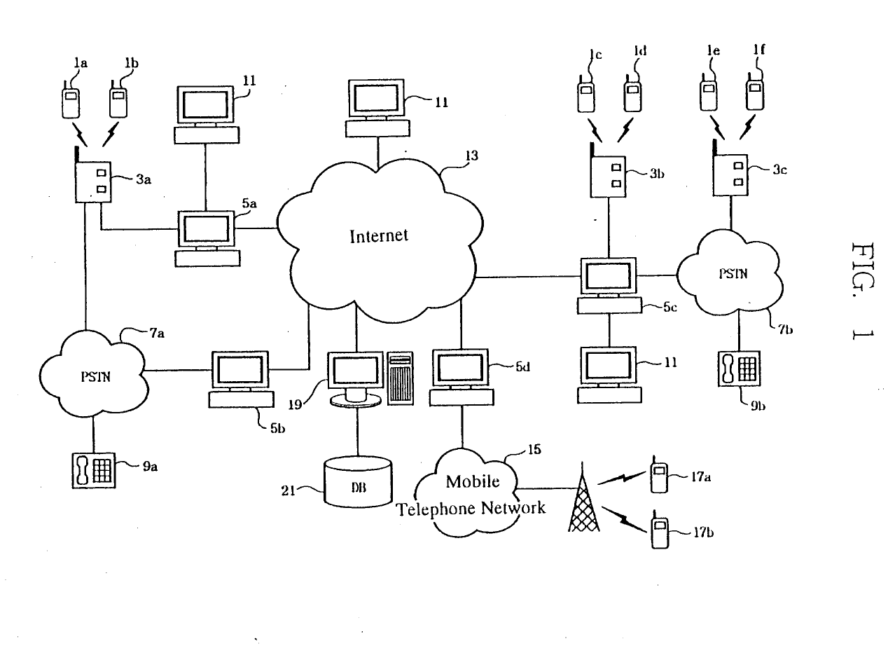

FIG. 1 is a concept diagram illustrating a wireless multimedia service providing method using Bluetooth in accordance with the present invention. Referring to FIG. 1, a system is shown which includes piconets established by Bluetooth terminals 1a to If (hereinafter, collectively referred to as “Bluetooth terminals 1”), and Bluetooth converters 3a to 3c (hereinafter, collectively referred to as “Bluetooth converters 3”), PSTNs 7a and 7b, to which telephones 9a and 9b adapted to provide existing telephone services are connected, respectively, a mobile telephone network 15, to which mobile terminals 17a and 17b (hereinafter, collectively referred to as “mobile terminals 17) are connected, and the Internet 13. The Bluetooth terminals 1 may be Bluetooth-dedicated terminals each only having an embedded Bluetooth chip, cellular phones, personal communication services (PCS) phones, or mobile terminals each configured by mounting a Bluetooth chip on a conventional mobile terminal, such as IMT-2000 terminals. The mobile terminals 17 are terminals having no embedded Bluetooth chip. The piconets are connected to the PSTNs 7a and 7b by their Bluetooth converters 3. The PSTNs 7a and 7b are connected to the Internet 13 via gateways 5a to 5c. Also, the piconets are connected to the Internet 13 via the gateways 5a to 5c. The gateways 5a to 5c may be gateways simultaneously supporting a general gateway function and a VoIP function. A computer 11 configured to support a VoIP may be directly connected to the Internet 13. In communications between the Bluetooth terminals 1, an ID server 19 performs an address resolution. The addresses of the Bluetooth terminals 1 managed by the ID server 19 are stored in a database 21. The ID server 19 and database 21 also manage the billing information of the Bluetooth terminals 1 and the kind of services.

In the embodiment of FIG. 1, wireless Internet phone services using Bluetooth can be provided in accordance with four types, that is, a first type in which a connection is established between the Bluetooth terminal 1 and the telephone 9a or 9b, a second type in which a connection is established between the Bluetooth terminal 1 and the computer 11, a third type in which a connection is established between the Bluetooth terminals 1, and a fourth type in which a connection is established between the Bluetooth terminal 1 and the mobile terminal 17.

In the embodiment of FIG. 1, wireless data services using Bluetooth can be provided in accordance with two types, that is, a first type in which a connection is established between the Bluetooth terminal 1 and the computer 11, and a second type in which a connection is established between the Bluetooth terminals 1.

In order to implement wireless multimedia services in accordance with the present invention, it is necessary to establish a connection between the Bluetooth network and the Internet 13. For this connection, a plurality of sequential procedures, that is, establishment of a piconet between the Bluetooth terminal 1 and the Bluetooth converter 3→establishment of transfer channels→transfer of multimedia data→conversion of Bluetooth network packets→connection between the Bluetooth converter 3 and the VoIP gateway 5, are carried out. Multimedia data passing through the Internet 13 is connected to the telephone 9, computer 11, mobile terminal 17, or Bluetooth terminal 1 via the PSTN 7, mobile telephone network 15 or Bluetooth network in accordance with the wireless multimedia service providing type.

As a representative example of services providable through a link between the Bluetooth network and the Internet in accordance with the embodiment of FIG. 1, there are wireless Internet phone services and data services (Internet services are more representative). Actually, the method of providing wireless Internet phone services and the method of providing wireless data services have many areas of similarity. Accordingly, the following description will be given mainly in conjunction with the wireless Internet phone service providing method. The multimedia service providing method using Bluetooth in accordance with the present invention will be described by additionally describing the difference of wireless Internet phone services from wireless data services.

Establishment of Piconet

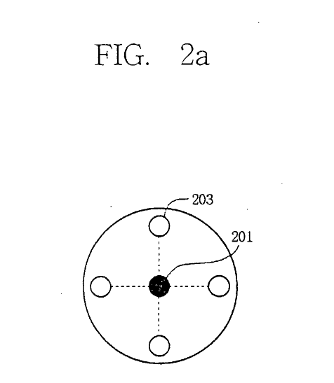

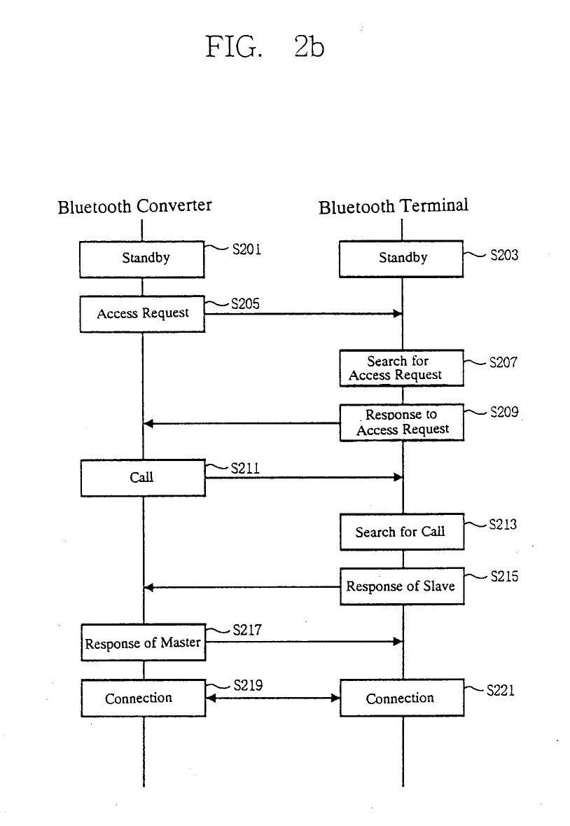

FIG. 2a illustrates the structure of a piconet established by Bluetooth. In one piconet, one master 201 and up to seven slaves 203 can be present. The master 201 not only manages the whole band usable by each slave 203, but also asynchronously transfers messages to the slaves 203. Accordingly, the slaves 203 cannot transfer data unless the data passes through the master 201.

In accordance with a preferred embodiment of the present invention associated with wireless Internet phone services, a piconet should be established between the Bluetooth converter 3 and the Bluetooth terminal 1. Generally, the master in the piconet is not fixed. That is, one of terminals establishing the piconet operates as the master to manage the wireless band to be used while synchronizing the remaining terminals, that is, slaves. In accordance with the present invention, however, the Bluetooth converter 3 is adapted to always operate as the master. For communications between one Bluetooth converter 3 and one Bluetooth terminal 1, which of the devices operates as a master is insignificant. However, where two or more Bluetooth terminals 1 communicate simultaneously with one Bluetooth converter 3, they should be synchronized with the Bluetooth converter 3 in order to achieve multiplexing. Since the slaves are synchronized with the master, the Bluetooth converter 3 has to operate as the master.

FIG. 2b shows a signaling flow for establishing a piconet between the Bluetooth converter 3 and the Bluetooth terminal 1. In this case, the Bluetooth converter 3 serves as the master, whereas the Bluetooth terminal 1 serves as the slave.

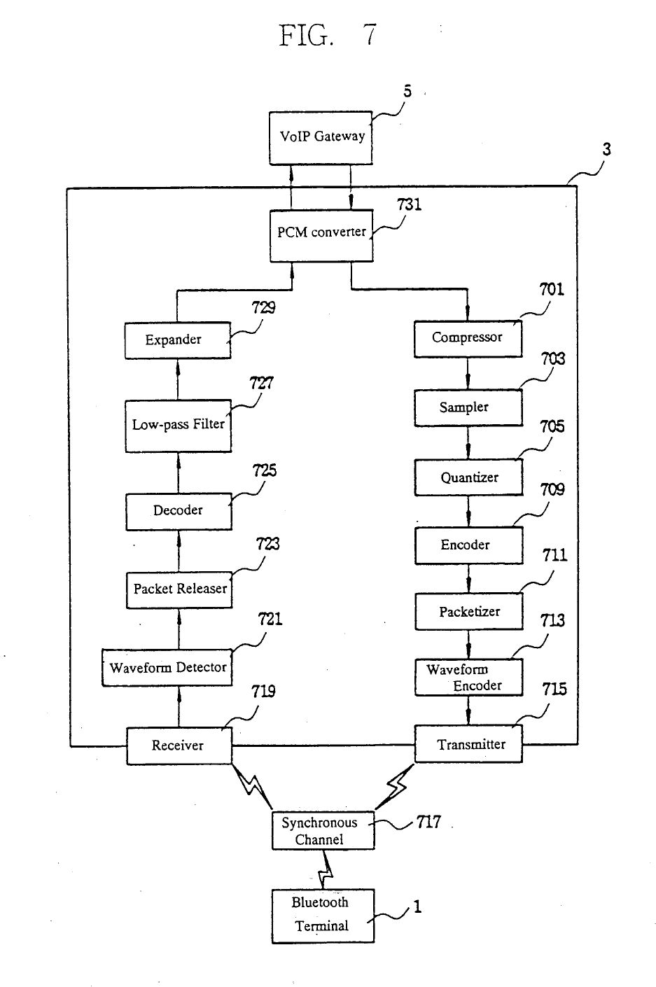

At steps S201 and S203, both the master and the slave are in a standby state. At access request step S205, using an inquiry access code (IAC) included in an access code 601 (FIG. 6a), the master inquires of the slave whether or not the slave desires to access the piconet managed by the master. The slave searches for an access request message at access request search step S207. When the slave detects an access request message from the master, it sends a response message to the request of the master at access request response step S209. Through the above described procedure, the master obtains information about the device address and clock of the slave. At step S211, the master calls the slave, using a device access code included in the access code 601. The slave detects a call message from the master at step S213, and sends, to the master, a response message to the call at step S215. In response to the call response message, the master sends a master response message to the slave at step S217. Thus, a piconet is established between the master and the slave at steps S219 and S221.

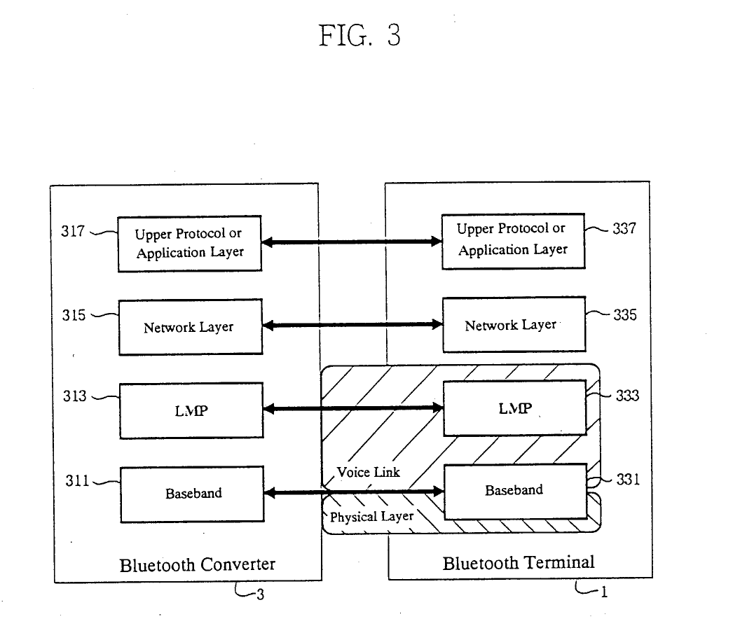

FIG. 3 illustrates the protocol architecture of a Bluetooth network used for transmission of voice signals. The above described signaling sequence for establishing the piconet is implemented over a link management protocol (LMP) layer 333. The Bluetooth terminal 1 and Bluetooth converter 3 includes respective baseband layers 311 and 331, which are physical layers, respective LMP layers 313 and 333 for controlling wireless synchronous links, respective network layers 315, and respective upper protocol or application layers 317 or 337.

For transfer of data signals, a logical link control and adaptation protocol (L2CAP) layer is used in place of the LMP layer 333. The L2CAP layer is used for signaling of asynchronous links.

Once the piconet between the Bluetooth converter 3 and the Bluetooth terminal 1 is established, the clock of the Bluetooth terminal 1 is synchronized with the master, that is, the Bluetooth converter 3. Where several Bluetooth terminals 1 are present in the piconet, the same operation as mentioned above is performed. The Bluetooth converter 3 periodically polls the Bluetooth terminal 1 managed thereby, thereby establishing a transfer channel for transmission and reception of data. Now, the channel establishment, and the transmission and reception of multimedia data will be described.

Establishment and Change of Synchronous Channel

For transfer of multimedia signals between the Bluetooth terminal 1 and the Bluetooth converter 3, a channel establishing procedure is carried out through signaling. In accordance with the present invention, voice signals use an SCO channel, whereas data signals use an ACL channel. The channel establishment may be initiated by the master, that is, the Bluetooth converter 3, or by the slave, that is, the Bluetooth terminal 1.

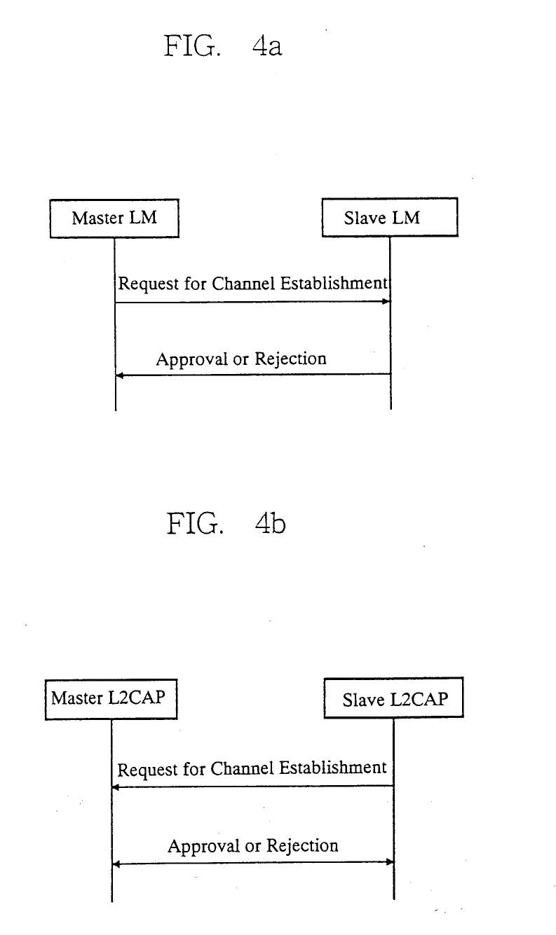

FIGS. 4a and 4b illustrate procedures for establishing a channel between the master and the slave, respectively. Referring to FIGS. 4a and 4b, it can be seen that signaling for multimedia communications is performed between the LMP layers of the master and slave or between the L2CAP layers of the master and slave. Both the master and the slave can transmit a channel establishment request message.

FIG. 4a shows the procedure of initiating a channel by the master. As shown in FIG. 4a, the master sends a channel establishment request message to the slave. In response to the channel establishment request message, the slave sends an approval or rejection message to the master. The channel establishment request message also contains parameters for setting the time, packet type, and code to be used for a synchronous link. For voice communications using the synchronous link, a voice packet is sent at intervals of a desired time after the time point of a slot initially sent.

FIG. 4b shows the procedure of initiating a channel by the slave. In this case, the channel establishment request message from the slave does not contain information about transmission slot and time, different from the case in which the master requests the channel establishment. The information is determined by the master, and then sent to the slave in a state in which it is included in an approval or rejection message. Where the master cannot immediately approve the channel establishment condition given by the slave, it stores the channel establishment condition, and subsequently establishes a channel according to the stored channel establishment condition at the point of time when the channel establishment condition is satisfied.

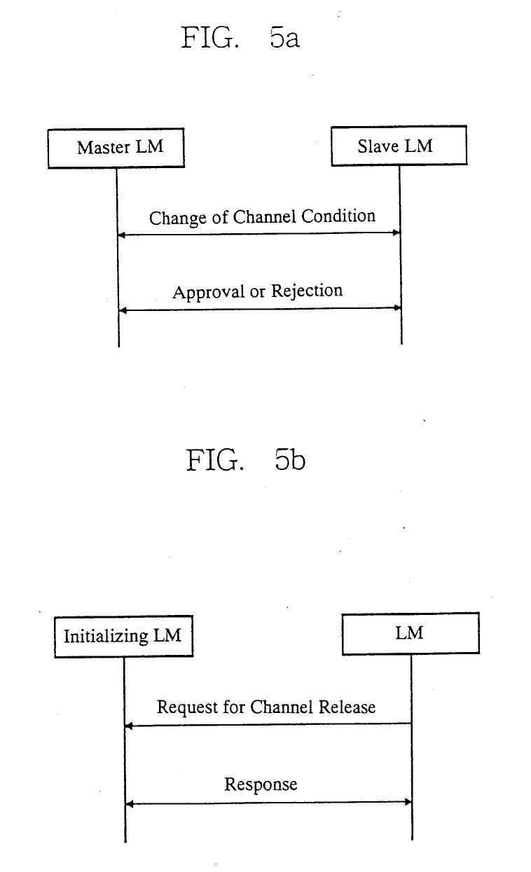

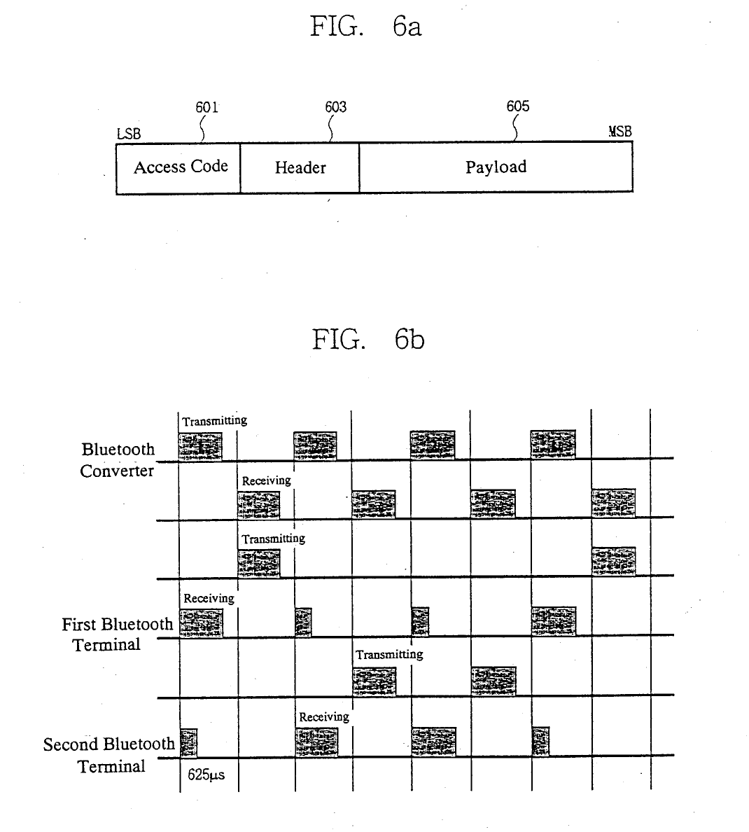

The channel condition established by the procedure of FIG. 4a or 4b is changeable. The change of the established channel condition is achieved between the LMP layer of the master, that is, the Bluetooth converter 3, and the LMP layer of the slave, that is, the Bluetooth terminal 1, or between the L2CAP layers of the master and slave. FIG. 5a shows the procedure of changing the channel condition between the master and the slave. A request for channel condition change can be initiated by the master or the slave. However, where the slave requests a channel condition change, it cannot request changes of specific parameters, for example, conditions of transmission slot and time. In response to the request for channel condition change, the master or slave sends to the counterpart an approval or rejection message.

FIG. 5b shows a signaling flow generated in response to a specific channel condition change request, that is, when the connection of the established channel is to be cut off. The initiating LM layer in FIG. 5b is that of the master or slave sending the channel establishment request message. Where the master or slave desires to release the established channel, it sends to the counterpart a channel release request message containing the reason to release the channel. The slave or master receiving the channel release request message has to send a response message.

Transfer and Multiplexing of Data

Once a channel is established between the master, that is, the Bluetooth converter 3, and the slave, that is, the Bluetooth terminal 1, it is possible to transfer multimedia data. In voice communications using an SCO link, a voice packet is transferred at intervals of a desired time. The interval and slot position are determined through the signaling sequence in the above described channel establishing procedure.

FIG. 6a shows the structure of a packet used in Bluetooth. As shown in FIG. 6a, the Bluetooth packet contains an access code 601, a header 603, and a payload 605. The access code 601 is used for the signaling between the master and the slave. The header 603 contains Bluetooth terminal address, packet type, and information about flow control. The payload 605 contains voice and data information.

As described above, transfer of voice is carried out on an SCO link. For transfer of voice data, only an HV packet is used. A synchronous port transfers a packet at intervals of a time determined in the procedure of establishing the SCO link while continuously recording next register values in an SCO buffer. On the other hand, transfer of data is carried out on an ACL link. In this case, packets are randomly transferred in accordance with an approval of the master, without being transferred at intervals of time. For the transfer of packets, a frequency hopping spread spectrum scheme is used. For exchange of packets between the master and the slave, a time-division duplex (TDD) scheme is used. Frequency hopping is changed by the unit of packets. That is, transfer frequency is changed for every packet.

In one piconet, two or more Bluetooth terminals can transfer multimedia data. Also, the master can receive voice signals from up to three slaves. To this end, it is necessary to use an appropriate multiplexing method between the master and the slave.

FIG. 6b shows a multiplexing transfer method performed between the master and two slaves. As described above, the Bluetooth converter 3 always operates as a master. In this case, therefore, the Bluetooth converter 3 serves as the master, whereas the Bluetooth terminals 1 serve as slaves. The master transfers a packet to the first slave at a first slot. At a second slot, the master receives data, which is transferred from the first slave in response to the packet received thereby. The same procedure is repeated between the master and the second slave. Accordingly, the first and second slaves can simultaneously exchange packets with the master, that is, the Bluetooth converter 3, in accordance with the above mentioned multiplexing transfer scheme.

One master can simultaneously exchange voice data with three slaves. Generally, piconets have a radius ranging from about 10 m to about 100 m. In accordance with the present invention, piconets preferably have a radius of 100 m. Accordingly, it is possible for four or more slaves to simultaneously request transfer of voice data in one piconet. In order to simultaneously provide voice data to four or more slaves, the Bluetooth converter 3 serving as the master in each piconet may have several embedded Bluetooth chips so that it operates respective masters of several piconets. For example, where two Bluetooth chips are embedded in one Bluetooth converter 3 so as to operate masters, respectively, it is possible to simultaneously provide voice services to six slaves.

Conversion of Data

In order to inexpensively provide wireless multimedia services, the Bluetooth network is connected to the Internet. To this end, the Bluetooth network has to be connected to a gateway.

FIG. 7 is a block diagram illustrating the configuration of a Bluetooth converter adapted to perform a conversion of voice data, received from a wireless Bluetooth terminal, into a format transferable to a wired network in accordance with an embodiment of the present invention. Referring to FIG. 7, there are shown a Bluetooth terminal 1, a synchronous channel 719, a Bluetooth converter 3, and a gateway 5. FIG. 7 also shows an internal configuration of the Bluetooth converter 3. The Bluetooth converter 3 includes a wireless interface part for providing a connection to a wireless Bluetooth network, a wired interface part for providing a connection to a wired network, and a conversion part for converting voice signals used in the wired and wireless networks. The conversion part of the Bluetooth converter 3 performs a function for converting voice codes and PCM signals used in the Bluetooth network.

First, the procedure for converting PCM signals into voice codes used in the Bluetooth network will be described. A PCM signal received from the VoIP gateway 5 is inputted to a PCM converter 731 which, in turn, converts the inputted PCM digital signal into an analog voice signal, and applies the analog voice signal to a compressor 701. After emerging from the compressor 701, the signal passes sequentially through a sampler 703 and a quantizer 705, so that it is converted into a digital signal. The digital signal is encoded for detection of errors by an encoder 709. The encoded digital voice signal is converted into a packet by a packetizer 711, and then modulated while passing through a modulator 713. The modulated radio frequency signal is transmitted to the Bluetooth terminal 1 on the synchronous channel 719 by a transmitter 715. The packetizer 711 forms the packet, to be used in Bluetooth, by prefixing an access code 601 and a header 603 (FIG. 6a) to the digital voice signal. Since the compressor 701, sampler 703, quantizer 705, modulator 713, and transmitter 715 are well known in the technical field, no further description thereof will be given.

The procedure for generating PCM signals by converting signals from the Bluetooth terminal 1 will now be described. A receiver 719 receives a modulated radio frequency signal from the Bluetooth terminal 1. The modulated signal is applied to a waveform detector 721 which, in turn, detects the waveform of the modulated signal, thereby recovering a digital signal. The recovered digital signal is applied to a packet releaser 723 which, in turn, detects a packet from the digital signal, and separates an access code 601 and a header 603 (FIG. 6a) from the packet, thereby recovering a digital voice signal. The recovered digital voice signal is subjected to an error detection and correction process in a decoder 725, and then applied to a low-pass filter 727. The signal emerging from the low-pass filter 727 is recovered into an analog voice signal by an expander 729 adapted to perform the inverse function of the compressor 701. The analog voice signal outputted from the expander 729 is converted into a PCM digital signal by a PCM converter 731. Since the configuration of the PCM converter 731 is well known in the technical field, no detailed description thereof will be given. The digital signal, which is outputted at 64 Kbps from the PCM converter 731, is transmitted to the VoIP gateway 5.

The Bluetooth converter 3 processes digital data signal other than voice data, in accordance with the following procedure.

First, where digital data from the Bluetooth converter 3 is to be transferred to the Bluetooth terminal 1, it is directly inputted to the encoder 709. After passing through the packetizer 711 and modulator 713, the digital data is transmitted to the Bluetooth terminal 1. At this time, an asynchronous channel other than the synchronous channel 717 is used as a wireless link. Where the Bluetooth converter 3 receives digital data from the Bluetooth terminal 1, the digital data is sequentially processed by the waveform detector 721, packet releaser 723, and decoder 725, so as to recover a digital data signal.

Connection Between Bluetooth Network and the Internet

Referring again to FIG. 1, the Bluetooth network and the Internet are connected via the Bluetooth converter 3 and VoIP gateway 5.

Where voice services are provided, PCM signals are transmitted and received between the Bluetooth converter 3 and the VoIP gateway 5. The VoIP gateway 5 transfers, over the Internet, a PCM signal after compressing the PCM signal, and converting the compressed signal into a packet in accordance with the above mentioned H.323 protocol. In a reverse procedure, the VoIP gateway 5 converts voice information, carried by an Internet packet, into a PCM signal, and transfers the PCM signal to the Bluetooth converter 3. In accordance with another preferred embodiment of the present invention, voice data other than PCM signals may be used. In this case, the Bluetooth converter 3 and VoIP gateway 5 should perform a conversion function meeting the voice data of the different type.

Where data services are provided, digital data is transferred to the general gateway 5 after being simply processed in accordance with a packetizing process.

In accordance with a preferred embodiment of the present invention, the Bluetooth converter 3 and gateway 5 may be connected to each other by a dedicated line of E1 or T1. Voice signals, which are converted into PCM signals by the Bluetooth converter 3, are transferred to the VoIP gateway 5 via the dedicated line. In the case of data signals, they are transferred to the gateway 5 on the dedicated line after being processed by an appropriate conversion process.

In accordance with another embodiment of the present invention, the Bluetooth converter 3 directly produces a TCP/IP packet. In this case, voice signals converted into PCM signals by the Bluetooth converter 3, and reproduced data signals are transferred to the gateway 5 under the condition in which they are packetized in the TCP/IP packet.

Connection to Receiving Terminal

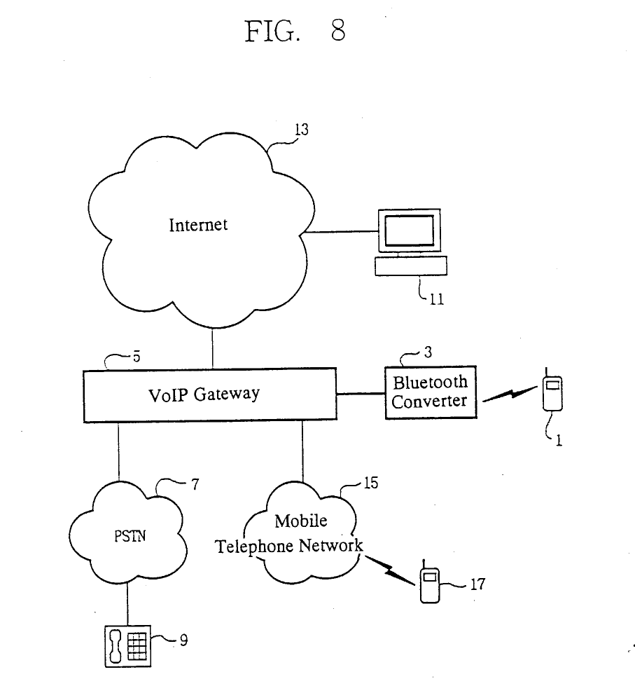

Voice information passing through the VoIP gateway 5 is transferred over the Internet while being carried by an Internet packet. Connection to a receiving terminal may be implemented in various types in accordance with the type of multimedia services to be provided by the present invention. FIG. 8 is a concept diagram corresponding to the part of the wireless multimedia service providing system associated with the receiving terminal. Connection to the receiving terminal will be described in association with service types, with reference to FIG. 8.

First, types of wireless Internet phone services will be described. The first type of Internet phone services according to the present invention is the case in which the receiving terminal is a telephone 9. In this case, the Internet 13, VoIP gateway 5, PSTN 7, and telephone 9 are connected together, as shown in FIG. 8. The receiving-end VoIP gateway 5 produces a PCM signal from an Internet packet. The VoIP gateway 5 is directly connected to the PSTN 7 so as to allow the transmitting-end user to be connected to the telephone 9 desired by him.

The second type of Internet phone services according to the present invention is the case in which the receiving terminal is a computer 11 supporting VoIP. In this case, the receiving computer 11 is directly connected to the Internet 13. In accordance with another embodiment of the present invention, the computer 11 may be connected to the Internet 13 via the receiving-end VoIP gateway 5. In this case, the receiving-end VoIP gateway 5 performs services supported by an upper protocol in order to real-time voice services. For example, jitter correction, error detection, and error correction are performed.

The third type of Internet phone services according to the present invention is the case in which the receiving terminal is a Bluetooth terminal 1. In this case, the transmitting Bluetooth terminal 1 is connected to the receiving Bluetooth terminal 1 via the Internet 13, receiving-end VoIP gateway 5, and receiving-end Bluetooth converter 3. The Bluetooth converter 3 performs a function for converting a PCM signal into a voice packet used in a Bluetooth network.

Where the receiving terminal is the Bluetooth terminal 1, it is necessary to determine the address of the receiving terminal. The procedure for determining the address of the receiving terminal will be described in brief, in conjunction with the embodiment of the present invention illustrated in FIG. 1. The address determining procedure involves a procedure for producing a database for the addresses of Bluetooth terminals 1, a procedure for searching the database for the address of the receiving Bluetooth terminal 1, and a procedure for updating the address of the receiving Bluetooth terminal 1.

First, the address database producing procedure will be described with reference to FIG. 1. The Bluetooth terminal 1 establishing a Bluetooth network sends its position to the ID server 19. The ID server 19 stores, in its database 21, the ID of the Bluetooth terminal 1, and the address of the gateway 5 connecting the Bluetooth network associated with the Bluetooth terminal 1 to the Internet 13. The ID of the Bluetooth terminal 1 is globally unique.

The searching procedure is carried out as follows. The transmitting Bluetooth terminal 1 requests the ID server 19 to search for the gateway 5, to which the receiving Bluetooth terminal 1 is connected. The ID server 19 searches its database 21 for the receiving-end gateway 5, to which the receiving Bluetooth terminal 1 is connected, and sends the searched result. The transmitting-end gateway 5 sends an IP packet to the address of the searched receiving-end gateway 5. Thus, data is transferred to the receiving Bluetooth terminal 1.

When a Bluetooth terminal 1, which establishes a Bluetooth network, and transmits/receives data, cuts off its connection to the Bluetooth network, it sends a connection ending message to the ID server 19 which, in turn, updates the gateway information associated with the Bluetooth terminal 1 in response to the message.

In accordance with this procedure, the ID server 19 can maintain position information about all Bluetooth terminals.

The fourth type of Internet phone services according to the present invention is the case in which the receiving terminal is a mobile telephone 17 having no embedded Bluetooth chip. In this case, the connection to the mobile telephone 17 is achieved via the Internet 13, VoIP gateway 5, and mobile telephone network 15.

Now, providing wireless data services will be described. As described above, wireless data services can be provided in accordance with two types, that is, a first type in which a connection is established between the Bluetooth terminal 1 and the computer 11, and a second type in which a connection is established between Bluetooth terminals 1. In the data service providing method of each type, connection to the receiving terminal is achieved in accordance with the same procedure as that of the wireless Internet phone service providing method, even though there is a difference in the conversion procedure performed by the Bluetooth converter 3 between the two methods. Therefore, no further description will be given.

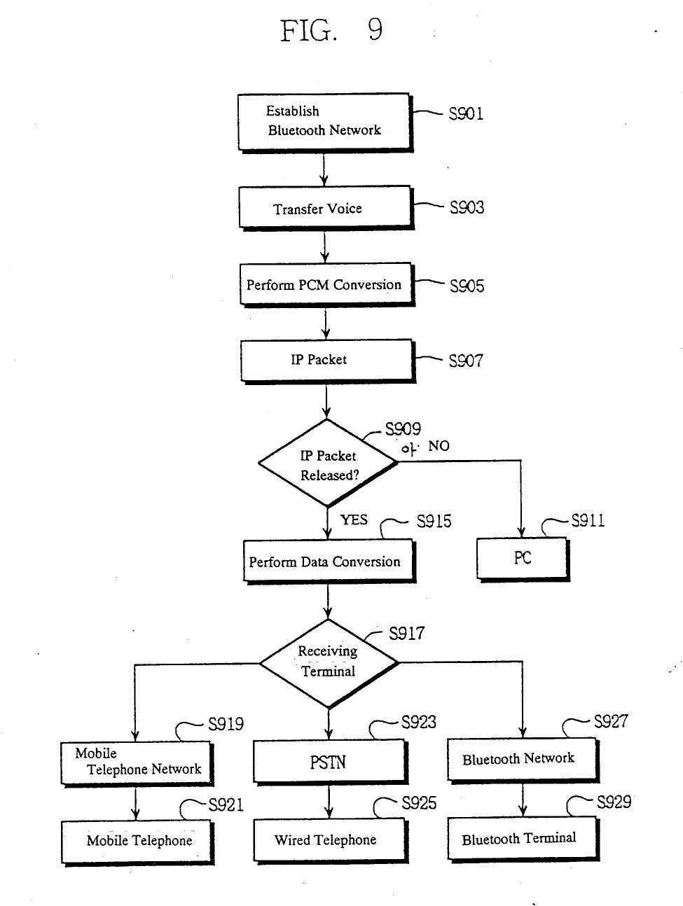

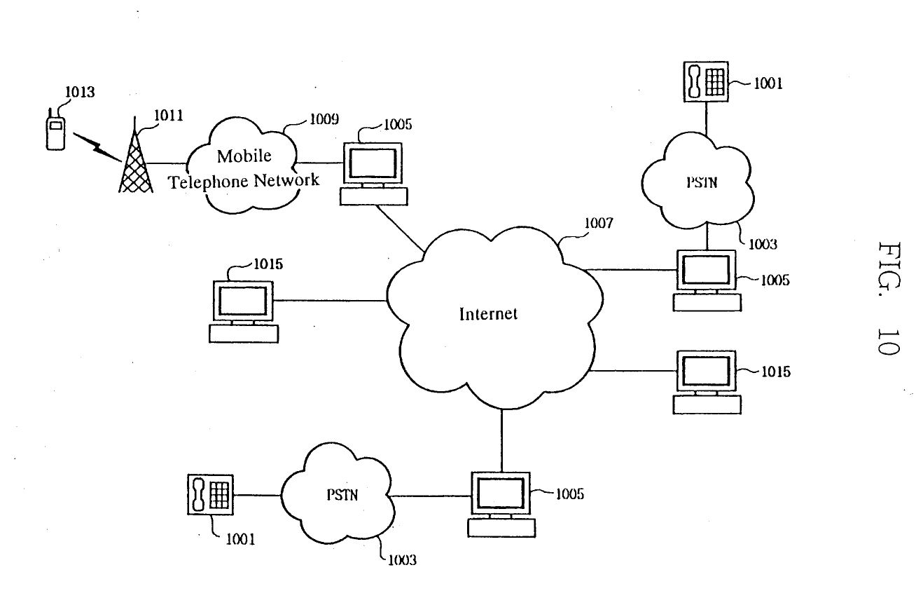

FIG. 9 is a flow chart illustrating a method for providing wireless multimedia services in accordance with the present invention.

Referring to FIG. 9, a Bluetooth network is established between the Bluetooth converter 3 and the Bluetooth terminal 1 at step S901. Once the Bluetooth network is established, the Bluetooth terminal 1 sends a multimedia signal to the Bluetooth converter 3 at step S903. At step S905, the Bluetooth converter 3 receives the multimedia signal, and converts the received signal into a PCM signal. The PCM signal is packetized into an IP packet by the VoIP gateway 5 at step S907. At step S909, the VoIP gateway 5 determines, based on the type of the receiving terminal, whether or not the IP packet is released. Where the receiving terminal is a computer 11 supporting VoIP, the procedure proceeds to step S911. At step S911, the receiving terminal directly receives the IP packet, thereby recovering the multimedia signal. In other cases, the procedure proceeds to step S915. At step S915, the IP packet is released to generate multimedia data. At step S917, the network, on which the multimedia data is to be transferred, is determined based on the type of the receiving terminal. Where the receiving terminal is a mobile telephone 17, the procedure proceeds to steps S919 and S921. At steps S919 and S921, a voice signal, which has been converted into a PCM signal at step S915, is transferred on the mobile telephone network 15, and then connected to the mobile telephone 17 after being converted into an appropriate format for wireless transmission. Where the receiving terminal is a wired telephone 9, the procedure proceeds to steps S923 and S925. At steps S923 and S925, the voice signal converted into the PCM signal at step S915 is connected to the wired telephone 9 via the PSTN network 7. Where the receiving terminal is a Bluetooth terminal 1, the procedure proceeds to steps S927 and S929. At steps S927 and S929, the converted voice or data signal is connected to the Bluetooth terminal 1 via the Bluetooth network. In this case, the voice or data signal passes through the receiving-end VoIP gateway 5, and the receiving-end Bluetooth converter 3.

The above described wireless multimedia service providing method using Bluetooth in accordance with the present invention may be variously implemented. For example, the method may be applied to a free internal office telephone network. This free internal office telephone network may be constructed in an office building to be provided with free internal office telephone services, as follows. At least one Bluetooth converter is installed on each floor of the office building. The Bluetooth converter of each floor is connected to a VoIP gateway via a dedicated line. The VoIP gateway may be internally installed in the building or externally installed at a place remote from the building. Persons working on each floor have Bluetooth terminals communicatable with the Bluetooth converter installed on the floor, respectively. Each Bluetooth terminal may be a mobile telephone mounted with a Bluetooth chip, or a terminal specially manufactured for free internal office telephone networks. Where an internal office telephone call is to be made, communications between Bluetooth terminals are established via a Bluetooth network. Where international telephone services or long-distance telephone services are to be provided using existing telephones, these services are possible by Internet phone services provided via the Bluetooth converter and VoIP gateway. Accordingly, using the Bluetooth network, it is possible to not only provide multimedia services between Bluetooth terminals, but also use long-distance and international multimedia services though a link to the Internet, without any charge.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As apparent from the above description, in accordance with the wireless Internet phone service providing method using Bluetooth, it is possible to not only inexpensively provide communication services between Bluetooth terminals, but also inexpensively use multimedia services conventionally incurring a considerable charge. In particular, expenses incurred due to use of telephone services can be reduced.

1. A system for providing wireless multimedia services using Bluetooth, comprising:
at least one Bluetooth terminal unit having an embedded Bluetooth chip able to transfer data;
a converter unit establishing a Bluetooth network with the Bluetooth terminal unit, the converter unit being connected with a wired network, and serving to convert data used in the Bluetooth network and the wired network; and
a gateway unit linked to the converter unit and adapted to perform a conversion between the data converted by the converter unit and an Internet packet,
wherein the converter unit comprises:
wireless interface means for wirelessly transmitting and receiving data to and from the Bluetooth terminal unit;
wired interface means for transmitting and receiving data to and from the gateway unit via a wired network; and
converter means for converting the data transmitted and received via the wireless interface means, and the data transmitted and received via the wired interface means.

2. The system according to claim 1, wherein the data is multimedia data including voice data.

3. The system according to claim 1, wherein the converter unit operates as a master of the Bluetooth network, and the Bluetooth network has a maximum service radius.

4. A Bluetooth converter device for establishing a Bluetooth network with at least one Bluetooth terminal, and transmitting and receiving data to and from the Bluetooth terminal, comprising:
wireless interface means able to transmit and receive data to and from the Bluetooth terminal;
wired interface means able to transmit and receive data to and from a wired network linked to the Bluetooth converter device; and
converting means for performing a conversion for signals exchanged via the wireless interface means, and data exchanged via the wired interface means.

5. The Bluetooth converter device according to claim 4, wherein the Bluetooth converter device operates as a master of the Bluetooth network, and the Bluetooth network has a maximum service radius.

6. The Bluetooth converter device according to claim 4, wherein the wireless interface means comprises:
antenna means able to transmit and receive radio frequency signals;
modulating/demodulating means linked to the antenna means and adapted to modulate/demodulate data at a radio frequency band;
packetizing means linked to the modulating/demodulating means and adapted to packetize data into a format defined by a Bluetooth protocol or to release a packet to extract data; and
encoding means adapted to perform an encoding/decoding function for a detection of errors on a radio channel.

7. The Bluetooth converter device according to claim 4, wherein the converting means operates to convert data carried by a payload of a Bluetooth packet into data to be transmitted to a gateway.

8. The Bluetooth converter device according to claim 4, wherein the wired interface means comprises means for providing an interface to a dedicated line adapted to provide a connection to a gateway.

9. A method for providing wireless multimedia services using Bluetooth, comprising the steps of:
establishing a Bluetooth network between at least one Bluetooth terminal and a Bluetooth converter;
receiving data from the Bluetooth terminal by the Bluetooth converter, and generating data converted from the received data by the Bluetooth converter;
transferring the converted data to a wired network by the Bluetooth converter.

10. The method according to claim 9, wherein the step of transferring the converted data to the wired network comprises the step of packetizing the converted data into an Internet packet.

11. The method according to claim 9, wherein the step of establishing the Bluetooth network comprises:
setting the Bluetooth converter as a master, setting the Bluetooth terminal as a slave, and setting the Bluetooth network to have a maximum service radius.

12. The method according to claim 9, wherein the step of transferring the converted data to the wired network comprises the steps of:
transferring the converted data to a transmitting-end gateway; and
packetizing the converted data into an Internet packet by the transmitting-end gateway.

13. The method according to claim 12, wherein the step of transferring the converted data to the wired network further comprises the step of:
following the packetizing step, receiving the Internet packet by a computer supporting a voice over Internet protocol.

14. The method according to claim 12, wherein the step of transferring the converted data to the wired network further comprises the steps of:
following the packetizing step, receiving the Internet packet by a receiving-end gateway;
extracting the converted data by the receiving-end gateway; and
transferring the extracted data from the receiving-end gateway to the wired network.

15. The method according to claim 14, wherein:
the wired network is a public switched telephone network, and the converted data is a pulse code modulation (PCM) signal; and
the PCM signal is received by a telephone connected to the public switched telephone network.

16. The method according to claim 14, wherein:
the wired network is a mobile telephone network; and
the converted data is received by a mobile telephone connected to the mobile telephone network.

17. The method according to claim 14, wherein:
the wired network is a dedicated line connected to a receiving-end Bluetooth terminal; and
the converted data is received by a receiving-end Bluetooth terminal establishing a Bluetooth network with the receiving-end Bluetooth converter.

18. A system for providing wireless multimedia services using Bluetooth, comprising:
at least one Bluetooth terminal unit having an embedded Bluetooth chip able to transfer data; and
a converter unit establishing a Bluetooth network with the Bluetooth terminal unit, the converter unit being connected with a wired network, and serving to convert data used in the Bluetooth network and the wired network,
wherein the wired network is the Internet, the converter unit comprises a unit for converting a packet used in the Bluetooth network into an Internet packet, and transferring the Internet packet over the Internet.

19. A system for providing wireless multimedia services using Bluetooth, comprising:
at least one Bluetooth terminal unit having an embedded Bluetooth chip;
a Bluetooth converter unit establishing a Bluetooth network with the Bluetooth terminal unit, the Bluetooth converter unit serving to convert multimedia data included in a Bluetooth packet; and
a gateway unit receiving the converted data from the converter unit, the gateway unit serving to convert the converted data into an Internet packet,
wherein the Bluetooth terminal unit operates as a slave, the Bluetooth converter unit operates as a master of the Bluetooth network, and the Bluetooth network established by the Bluetooth terminal unit and the Bluetooth converter has a maximum service radius.

20. The system according to claim 19, wherein the gateway unit is a gateway for a voice over Internet protocol.

21. The system according to claim 19, wherein the gateway unit simultaneously perform operations of a gateway for a voice over Internet protocol and a general gateway.

22. The system according to claim 1, further comprising:
an ID server for storing an ID of the Bluetooth terminal unit, and an ID of the gateway unit.

23. The system according to claim 19, further comprising:
an ID server for storing an ID of the Bluetooth terminal unit, and an ID of the gateway unit.

24. The system according to claim 23, wherein the ID server provides an ID of a receiving-end one of Bluetooth terminals respectively connected to different gateway units, and an ID of a receiving-end one of the gate way units when a connection between the Bluetooth terminals is established.
